(19) United States
(12) Patent Application Publication
(10) Pub. No.: US 2026/0329253 A1
(43) Pub. Date: Oct. 22, 2026

(54) METHOD FOR OPTIMISING THE TIME OF LASER MACHINING OF AN OBJECT

(71) Applicant: SCANLAB GMBH, Puchheim (DE)

(72) Inventors: Gerald Schmid, Fuerstenfeldbruck (DE); Christian Sonner, Dachau (DE)

(21) Appl. No.: 19/113,990

(22) PCT Filed: Sep. 14, 2023
(86) PCT No.: PCT/EP2023/075236

§ 371 Date: Mar. 21, 2025

(30) Foreign Application Priority Data
Sep. 21, 2022 (DE) 10 2022 124 311.7
Dec. 22, 2022 (DE) 10 2022 134 609.9

(51) Int. Cl. G05B 19/4099; B23K 26/082

(52) U.S. Cl. CPC G05B 19/4099; B23K 26/082; G05B 2219/45165

(57) ABSTRACT

A computer-implemented method for optimizing the time of laser machining of an object, in which a laser can be guided along a predefined machining path on the object by a galvo scan system. The method includes determining: (1) a location-dependent energy input profile for energy input by the laser into the object along the machining path; (2) a location-dependent first power profile L₁ of the laser along the machining path; (3) a location-dependent idealized velocity profile on the basis of the location-dependent first power profile and the location-dependent energy input profile; (4) a time-dependent path progress such that a reachable velocity profile of the laser along the machining path is limited by the location-dependent idealized velocity profile and at least one dynamic limit of the galvo scan system is adhered to along the machining path; and (5) a time-dependent second power profile.

### CROSS-REFERENCE TO RELATED APPLICATIONS

The present application is a national phase entry of International Patent Application No. PCT/EP2023/075236, filed on Sep. 14, 2023, which, in turn, is based upon and claims the right of priority to German Patent Application No. 10 2022 124 311.7, filed Sep. 21, 2022 and German Patent Application No. 10 2022 134 609.9, filed Dec. 22, 2022, the disclosure of which is hereby incorporated by reference herein in its entirety for all purposes.

### FIELD OF THE INVENTION

The present subject matter relates to a method, in particular to a computer-implemented method, for optimizing the time of laser machining of an object, in which a laser can be guided along a predefined machining path on the object by a galvo scan system, and in which a location-dependent energy input profile E(s) for energy input by the laser into the object along the predefined machining path is defined. The present subject matter also relates to a method in which a location-dependent first power profile L₁(s) of the laser along the machining path is defined, and in which a location-dependent idealized velocity profile vₘₐₓ(s) is calculated on the basis of the location-dependent first power profile L₁(s) and the location-dependent energy input profile E(s). Moreover, a time-dependent path progress s(t) is calculated such that a reachable velocity profile v(s) of the laser along the machining path is limited by the location-dependent idealized velocity profile vₘₐₓ(s) and at least one dynamic limit of the galvo scan system is adhered to along the machining path. A time-dependent second power profile L₂(s(t)) is calculated, the location-dependent first power profile L₁(s) being reduced such that the location-dependent energy input profile E(s) is achieved at locations (s) on the machining path at which the reachable velocity profile v(s) is lower than the location-dependent idealized velocity profile vₘₐₓ(s).

### BACKGROUND OF THE INVENTION

In laser machining or in laser treatment, the objective in general is to achieve a machining passage time that is as high as possible or a treatment time that is as short as possible. To this end, the path velocity can be selected to be as high as possible in accordance with the available power of the laser and the properties of the laser process and defined as the laser speed for the laser process.

Similarly, a higher speed (skip speed) can be provided for skips (with the laser shut off) between various sections of the machining path in order to shorten the overall machining time.

A real-time control of the galvanometer scan system provides typically automatic functions for these methods, which functions carry out adaptation corrections for the run time of the laser material machining (for example, SCANLAB RTC6 automatic laser control/function spot distance control) on the basis of control data or sensor values.

These functions can generally be configured by the user. Known dependencies of the process on one or more process parameter(s) can be stored in a characteristic curve or a parameter table, on the basis of which the laser power can be set correctly in accordance with one or more process parameters. For example, the generated grayscale value of a laser-marked pixel of an image can correlate with the laser power to be used via a non-linear function (for example, gamma correction). For example, the laser power can also be corrected in accordance with the scan position and/or a defocusing of the laser. In particular, the required laser power can also correlate with the path velocity of the scanner in a non-linear manner.

Typically, the position-controlled galvanometer scanners do not follow the predefined path exactly, but rather with a temporal tracking error due to the properties of the position controller. The tracking error is typically compensated for by a time delay of the laser actuation (“laser delay”), as a result of which the path deviations (tracking errors) can be largely corrected at least along straight paths having a constant path velocity.

WO 2020/025771 A1 describes a method for laser machining an object.

### SUMMARY OF THE INVENTION

In various aspects, the problem(s) of the prior art is/are addressed by the present subject matter via a method, computer program, computer-readable storage medium and/or device that allows for more quickly carrying out laser machining or laser treatment.

Specifically, in various aspects, the problem(s) of the prior art is addressed by a method, computer program, computer-readable storage medium, and/or a laser machining device having the features described and claimed herein.

In one aspect, the present subject matter relates to a method, in particular to a computer-implemented method, for optimizing the time of laser machining of an object, in which a laser can be guided along a specified machining path on the object by a galvo scan system. When the laser is guided, a beam of the laser is guided and moved over the object, thereby machining the object. The object can be a workpiece, which is, for example, cut, welded, and/or engraved. The workpiece can also be machined such that regions on the surface are ablated.

Additionally or alternatively, the object can also be a body part when the laser machining is used for medical purposes. The object can also be a textile piece which is to be marked. Here, a dye on the textile piece can be dissolved using the laser, so that the corresponding point is bleached.

In the method, a location-dependent energy input profile E(s) for energy input by the laser into the object along the predefined machining path is defined. The location-dependent energy input profile E(s) indicates how high the energy input is at which locations along the machining path. If, for example, material on the workpiece is to be removed, the amount of material removed depends at least on the energy input. The location-dependent energy input profile E(s) is therefore a specified-value profile or is calculated on the basis of a specified-value profile. The specified-value profile can indicate how the machined object is to appear after the machining.

In the method, a location-dependent first power profile L₁(s) of the laser along the machining path is defined, and a location-dependent idealized velocity profile vₘₐₓ(s) is calculated on the basis of the location-dependent first power profile L₁(s) and the location-dependent energy input profile E(s). The location-dependent first power profile L₁(s) can be defined to be as high as possible in order to obtain a high energy input in a short time. For example, the location-dependent first power profile L₁(s) can be the maximum laser power or at least come close to the maximum laser power. The location-dependent idealized velocity profile vₘₐₓ(s) indicates the maximum velocity of the laser along the machining path, at which, in consideration of the location-dependent first power profile L₁(s), the location-dependent energy input profile E(s) is just reached.

In the method, a time-dependent path progress s(t) is also calculated such that a reachable velocity profile v(s) of the laser along the machining path is limited by the location-dependent idealized velocity profile vₘₐₓ(s) and at least one dynamic limit of the galvo scan system is adhered to along the machining path. Although the location-dependent idealized velocity profile vₘₐₓ(s) is the optimum, this optimum cannot be reached due to the dynamic limit of the galvo scan system. To this end, the time-dependent path progress s(t) is calculated such that the reachable velocity profile v(s) adheres to the dynamic limits. This profile is then limited by the location-dependent idealized velocity profile vₘₐₓ(s), i.e., the location-dependent reachable velocity profile v(s) does not exceed the location-dependent idealized velocity profile vₘₐₓ(s) at any location.

Moreover, the machining path on the object can be calculated on the basis of the time-dependent path progress s(t), which machining path can be represented as p(s(t)). The functional relationship p(s(t)) can have, for example, two components, i.e., be two-dimensional. Alternatively, p(s(t)) can also have three components, i.e., be three-dimensional. The functional relationship p(s(t)) indicates the coordinates of the laser on the object. For example, p(s(t)) can be defined in a Cartesian coordinate system which describes the coordinates of the laser on the object. The functional relationship p(s(t)) can also be represented as a vector in accordance with the time-dependent path progress s(t).

In order to compensate for the location-dependent reachable velocity profile v(s), which is limited relative to the location-dependent idealized velocity profile vₘₐₓ(s), a time-dependent second power profile L₂(s(t)) is calculated, the location-dependent first power profile L₁(s) being reduced such that the location-dependent energy input profile E(s) is achieved at locations (s) on the machining path at which the reachable velocity profile v(s) is lower than the location-dependent idealized velocity profile vₘₐₓ(s).

The location-dependent energy input profile E(s) or merely the target energy input or the energy input describes the effect that the user wants to achieve on the workpiece in the process. The energy per unit length that is necessary for this purpose can be constant (energy per unit length), for the purpose of which the mean power of the laser can be proportionally selected in accordance with the feed rate (scan speed). The present subject matter can also relate to more complex situations in which, for example, dyeing can be adjusted by means of the interaction of the laser with certain combinations of process parameters such as feed rate, focusing, and/or laser power, between which a non-linear relationship exists, which must be taken into account to ensure the required energy input. The laser power can be adjusted, in particular, by pulse energy, pulse duration, and/or pulse frequency.

It is advantageous when the time-dependent path progress s(t) is calculated such that a machining time of the machining path is minimized. As a result, the time of laser machining is optimized.

It is advantageous when the time-dependent path progress s(t) is calculated such that the reachable velocity profile v(s) of the laser becomes maximum at least in sections. Due to the maximum reachable velocity profile v(s), the machining time of the machining path is reduced.

It is advantageous when the time-dependent path progress s(t) is calculated by means of an optimization method and/or an optimization algorithm. Various optimization methods for this purpose are known. For example, in the optimization method, multiple different time-dependent path progresses s(t) can be determined and, on the basis of these, the time-dependent path progress s(t) can be selected that yields the shortest machining time of the machining path. Additionally or alternatively, the time-dependent path progress s(t) can be calculated using a system of differential equations, into which system the dynamic limits, the location-dependent energy input profile E(s), the location-dependent first power profile L₁(s), and/or the location-dependent idealized velocity profile vₘₐₓ(s), as the boundary conditions, are incorporated.

It is advantageous when the time-dependent path progress s(t) is calculated such that a dynamic limit of the laser, in particular of the laser power, is adhered to. A dynamic limit of the laser is, for example, the fact that the laser power cannot be changed with unlimited speed. For example, a rate of change with respect to time dL(t)/dt or the rate of change with respect to location dL(s)/ds is limited.

It is advantageous when the time-dependent path progress s(t) is calculated such that the dynamic limit of the galvo scan system that is adhered to is an acceleration limit and/or a jerk limit. The acceleration limit and/or a jerk limit is due, in particular, to the inertia of deflection mirrors of the galvo scan system, the physical limits of the galvanometer drives, and the power supply of the galvanometer drives, and properties of the utilized position control method for the closed-loop control of the angular position of the deflection mirrors. The velocity, the acceleration, and/or the jerk are generally vector quantities. The aforementioned dynamic limits for the acceleration and/or the jerk can also be adhered to for at least one vector component. Additionally or alternatively, an absolute value of the acceleration vector and/or of the jerk vector can also be taken into account when adhering to the dynamic limits. This means that at least one, in particular all, vector component(s) and/or the absolute value of the corresponding vector adhere to the dynamic limits.

The dynamic limits are, in particular, limitations of the permissible value ranges of the first, the second, and the third time derivatives of p(s(t)). The dynamic limits can be, in particular, limitations of the value ranges for the second and the third time derivatives of vector components of p(s(t)). The dynamic limits correspond to the upper limit for jerk and/or acceleration of the galvanometer drives in the galvo scanner.

This approach is particularly advantageous when a scan system having a tracking error-free controller for closed-loop control is used, in which the dynamic limits can be described with good approximation using acceleration limits and/or jerk limits of the galvo scanner, and the time behavior of the system when implementing an acceleration-limited and/or jerk-limited trajectory can be predicted with high precision.

It is advantageous when the time-dependent path progress s(t) is calculated such that the time-dependent path progress, the reachable velocity profile, and/or profiles which can be derived from these, in particular by means of a time derivative, are continuous and/or continuously differentiable, in particular smooth. Profiles which can be derived from the time-dependent path progress s(t) are, for example, the time derivatives ds(t)/dt as the reachable velocity profile, d²s(t)/dt² as the acceleration profile, d³s(t)/dt³ as the jerk profile, and even higher derivatives. Additionally or alternatively, other profiles can also be derived from the time-dependent path progress s(t) when the path progress s(t) is used to calculate other profiles. When the aforementioned profiles are continuous and/or continuously differentiable, in particular smooth, these have advantageous movement properties.

It is advantageous when the location-dependent first power profile L₁(s), the reachable velocity profile v(s) calculated on the basis of the time-dependent path progress, profiles which can be derived from the time-dependent path progress s(t), in particular by means of the time derivative, and/or the time-dependent second power profile L₂(s(t)) are calculated and/or defined such that these are staircase-shaped and/or constant in at least some path sections along the machining path. As a result, the calculation and/or the actuation of the laser and/or of the galvo scan system can be simplified. For example, the location-dependent energy input profile E(s), the location-dependent first power profile L₁(s), and/or the location-dependent idealized velocity profile vₘₐₓ(s) can be calculated and/or defined in a staircase-shaped and/or constant manner in order to address specific machining tasks or when the limitations are sufficient for the machining tasks. The optimization can be more easily carried out as a result. Moreover, due to the staircase-shaped and/or piecewise constant shape of the aforementioned profiles or function, the associated values are stored and/or can be stored in value tables. The optimization by means of the discrete values allows for a simpler calculation and an adapted calculation. If the staircase-shaped sections or the piecewise constant sections are selected to be small, the corresponding profiles and functions can be more precisely determined. If the staircase-shaped sections or the piecewise constant sections are selected to be larger, less time is required for the calculation. In addition, the size of the piecewise constant sections of the aforementioned profiles and functions can be selected such that the temporal machining or treatment of the sections takes place in the range of one cycle of the controller. In particular, it is advantageous when the location-dependent energy input profile E(s) is staircase-shaped and/or constant in at least some path sections along the machining path. Such a location-dependent energy input profile E(s) can be present as input data or a specified value, for example, in a table. This can be the case when there are specific customer requests, wherein the time optimization can also be more easily carried out using the discrete location-dependent energy input profile E(s).

It is advantageous when an orientation and/or a positioning of the galvo scan system with respect to the machining path is also taken into account in the calculation of the time-dependent second power profile L₂(s(t)) and/or of the location-dependent idealized velocity profile vₘₐₓ(s). If the object is oriented, for example, at an angle to the galvo scan system and thus at an angle to the laser, the laser is incident on the object and the machining path at an angle. As a result, the full power is no longer applied into the machining path. Moreover, the machining path can no longer be passed through at the highest possible velocity, so that the location-dependent idealized velocity profile vₘₐₓ(s) can also be taken into account in the calculation.

It is advantageous when the time-dependent coordinates p(s(t)) for the machining path (4) are determined for the galvo scan system on the basis of the time-dependent path progress s(t) for moving the laser along the machining path. The coordinates p(s(t)) are for example, a two-dimensional vector having the components pₓ(s(t)) and p_{y}(s(t)). Alternatively, the coordinates p(s(t)) can also be a three-dimensional vector, so that the position of the laser in space can be described. These indicate the coordinates of the machining path on the object. These are then converted by the galvo scan system into time-dependent angular positions for deflection mirrors of the galvo scan system, so that the laser is moved along the machining path.

It is advantageous when the method for optimizing the time of laser machining of an object is carried out by a computer unit.

It is advantageous when the coordinates p(s(t)) are transmitted to a galvo control unit of the galvo scan system and the time-dependent second power profile L(s(t)) is transmitted to a laser controller. The laser controller controls the power of the laser, so that the time-dependent second power profile L(s(t)) is formed. It is advantageous when, subsequent to the transmission, the object is machined. Preferably, the object is machined after the time of the machining path has been optimized. The time optimization of further machining paths of the entire machining task or of sections of the path can also optionally be carried out simultaneously with the machining of the previously calculated paths or path sections. The entire machining task can be dissected into path sections for this purpose, which path sections represent machining paths in the sense of the method according to the present subject matter. In this approach, there are high requirements on the time efficiency of the method for optimizing the time.

It is advantageous when the laser machining is simulated by a computer prior to the real laser machining of the object. In so doing, for example, an operating behavior of the laser machining can be simulated. In this way, it can be, for example, simulated and determined whether the laser machining can be carried out with the reachable velocity profile v(s) and/or the time-dependent second power profile L₂(s(t)). Additionally or alternatively, it can be simulated and/or determined whether the machining path is machined using the determined profiles correctly or within tolerance specifications. Additionally or alternatively, the time required to machine the machining path can be simulated and/or determined. The simulation has the advantage that a subsequent correction can be carried out when it becomes apparent in the simulation that the laser machining is proceeding in a faulty manner or not as desired. Subsequently, the laser machining or the method for optimizing time can be adapted or changed.

It is advantageous when the real laser machining of the object is carried out once the time of the laser machining has been optimized. Additionally or alternatively, the real laser machining of the object can be carried out after the simulation of the laser machining. This has the advantage that the sequence of the laser machining is then known, so that errors in the machining can be avoided.

The present subject matter also relates to a method, in particular to a computer-implemented method, for optimizing the time of laser machining of an object using a laser machining device having a galvo scan system and a laser, in which an energy input by a laser is predefined or specified for multiple path sections of a predefined machining path, which energy input depends on a laser power and a laser speed of the laser in the path section. In the method, a first laser power of the laser, in particular a constant and/or maximum laser power, over the path sections is defined. An idealized laser speed, at which the energy input in the path section is achieved, is subsequently determined for the path sections while taking into account the first laser power. Thereafter, the idealized laser speed is adapted, in particular reduced, to a reachable laser speed under consideration of at least one dynamic limit of the galvo scan system and/or of the laser. In the path sections in which an adaptation to the reachable laser speed has been carried out, the first laser power is subsequently adapted, in particular reduced, to a second laser power such that the energy input is achieved. It is advantageous when the energy input, the laser power, in particular the first and/or the second laser power, the laser speed, in particular the idealized laser speed and/or the reachable laser speed, are preferably present as time-dependent and/or location-dependent mathematical functions. Additionally or alternatively, it is advantageous when the energy input, the laser power, in particular the first and/or the second laser power, the laser speed, in particular the idealized laser speed and/or the reachable laser speed, is either constant in at least one of the path sections or varies in a time-dependent and/or location-dependent manner.

Preferably, the present subject matter is additionally or alternatively designed according to the preceding description and/or the following description, wherein the aforementioned features can be present individually or in any combination.

In order to machine a workpiece, a laser can be guided over a workpiece along a path using a galvanometer scanner. Optionally synchronously, the position of the focus along the laser beam can be adjusted using a dynamically variably adjustable focusing device in order to guide the laser focus in three spatial dimensions along a path. In this case, the path p(s(t)) is described using three vector components of p, for example, p=(pₓ,p_{y},p_{z}). The machine result can be, for example, a laser marking, a laser ablation, a laser weld seam, or a laser cut. In order to achieve the desired machining result with a high level of accuracy, both the path of the laser focus relative to the workpiece and the properties of the laser beam are to be synchronously controlled in order to adjust the local energy input. Depending on the type of the laser, for example, a variation of the energy input can be adjusted by changing the mean power or the energy, duration, or frequency of pulses or a pulse duty factor in the modulation. The laser can be switched off in regions that are not to be machined and switched on again on the machining paths.

Due to the high requirements on the synchronicity, lasers, galvanometer scanners, the focusing device, and/or, optionally, further axes of movement, can be actuated by a real-time control system designed specifically for this purpose (for example, SCANLAB RTC6).

Depending on the application, the objective of the machining can be, for example, a homogeneous input of energy along the path or a targeted local variation, for example, in the laser marking of an image line of a rasterized image having grayscale information (bitmap) which is present for each pixel, i.e., in a spatially resolved manner.

The present subject matter therefore relates to a method having one or more of the following features:
Starting point is a predefined geometry of the machining path p(s) and values of a target energy input E(s) at least for support points at locations along the path (s: path parameter, i.e., route along the path); and/or
use of a galvanometer scan system having a “trajectory controller” (i.e., having a position control method without tracking error); and/or
use of a laser which allows for a variable adjustment of at least one parameter for influencing the mean laser power within an adjustment range and the limits of laser dynamics. The necessary laser power parameters L for reaching an energy input E are described by a functional relationship L(E); and/or
use of a computer unit for optimizing the machining plan; and/or
optimizing the run time of the path (trajectory) p(s(t)) by maximizing the profile of the path progress velocity ds/dt using an optimization algorithm,
   wherein the control limits and dynamic limits of the galvanometer scan system (axis-specific positions, velocities, acceleration and, optionally, also jerk) are preferably not exceeded (necessary for the algorithm: conversion into limits for ds/dt and d²s/dt², d³s/dt³); and/or
   the minimally necessary machining time determined on the basis of the target energy input E(s), the maximum available laser power L(E), and/or the dynamic limits of the change in laser power (dL/dt, . . . ), and thus the maximum possible path velocity in accordance with s, is not exceeded (i.e., an additional upper limit for ds/dt); and/or
using the function s(t) determined in this way, the time profile of the scanner actuation p(s(t)) and/or the time profile of the laser power specification L(E(s(t))) is calculated on the basis of the predefined energy input E(s) per unit length; and/or
transferring the thus pre-planned trajectory p(s(t)) and the time profile of the laser power L(E(s(t))) to a real-time control system; and/or
synchronously outputting actuation data for the galvanometer scan system and the laser on the basis of the pre-calculated trajectory and the time profile of the laser power (wherein a signal
processing/conversion/temporal rasterization of the particular signals for the laser and the galvanometer scanner can be carried out independently of one another).

Depending on the process and on the laser used in combination with the deflection system (scanner), different relationships result between the target energy input E and the laser parameters L to be adjusted, which laser parameters must be described by the function L(E). This generally, in particular, non-linear relationship can be approximated by means of characteristic curves.

The function L(E) is, in particular, dependent on the path velocity of the laser and, therefore, can be a function L(E,v) of both parameters. In general, when a path velocity is higher, a higher laser power L is adjusted in order to achieve the same energy input. The relationship depends on the physics of the laser interaction with the material of the object and can be approximately linear with respect to velocity, or non-linear.

The function L(E) can include a correction (compensation for the optical imaging) depending on the positioning of the laser focus by the scan system.

The function E(s) can be defined as piecewise constant or linear and/or as having equidistant support points. For example, marking a row of a bitmap (grayscale image) or at the beginning and the end of welding processes The predefined geometric path can be a line of a rasterized grayscale image and/or the predefined target energy inputs can be piecewise constant and equidistant in order to image the gray scale values of the pixels of the grayscale image.

For a galvanometer scan system having a trajectory controller, the pre-calculated trajectories are preferably limited at least with respect to velocity and acceleration. An improvement in adherence to the path can be achieved by additionally limiting jerk.

It is advantageous when a maximum possible velocity is determined in the pre-planning on the basis of the geometric profile of the path, at which maximum possible velocity all dynamic limits of the galvanometer scan system can be adhered to. When paths are curved, a local maximum velocity can be determined, at which the acceleration limits and the jerk limits of the galvanometer scan system are not exceeded in any axial direction.

The complexity of the calculation of a jerk-limited trajectory which has been optimized for time is high. In order to save computing time, a smoothing method can be used to calculate an acceleration-limited and/or jerk-limited trajectory, in particular to calculate a jerk-limited trajectory on the basis of an acceleration-limited trajectory.

The galvanometer scan system can have two galvanometer axes and the path can be a 2D path which lies in a machining plane in a focus plane.

The galvanometer scan system can include a dynamic focusing system and the path can be a 3D path, in particular a path that is located on a non-planar surface of a workpiece.

The galvanometer scan system can be combined with further slower redundant axes, wherein the planning can include distributing the movement onto the axes of the galvanometer scanner and the redundant axes. The further axes can move the workpiece relative to the galvanometer scan system or move the galvanometer scan system relative to the workpiece.

The galvanometer scan system can have four galvanometer axes in order to thereby dynamically adjust the beam position and the beam direction in two axes. The process parameters then also include, in particular, the angle of incidence of the laser beam. This 4-axis system can be supplemented by a focusing unit, so that the machining spacing is also variable.

In the pre-planning, a defocusing of the beam, which can occur due to the limited dynamics of the focusing unit, can be compensated for by adapting (increasing) the laser power. Alternatively, a buffer adjustment range of the laser power can be provided, which is reserved in the pre-planning in order to be able to carry out real-time compensation while machining is being carried out.

Deterministic pre-planning and open-loop control, rather than real-time compensation or rather than iterative optimization of the actuation via trial and error, is advantageous. Advantageously, the machining is carried out at a higher scan speed along the path at points having a lower target energy input. Moreover, it is advantageous when the limit of the available laser power is taken into account by calculating the profile of a local maximum velocity according to the local target energy input (in an intermediate step). It is also advantageous when the execution with respect to time is optimized while taking into account the dynamic limits of the scan system and/or of the laser.

It is advantageous when a tracking error-free controller of the galvanometer scan system is used, the use of which preferably requires a pre-calculation of the target value profile (trajectory planning) in order to limit acceleration and/or jerk along the path. With tracking error, it would be practically impossible to correctly pre-calculate the time profile of the laser power at a variable speed of the scan system, since the time behavior of the controller is difficult to modulate and, thus, the precise path-specific introduction of the target energy input cannot be meaningfully pre-calculated. For the case of such a system, an iterative approach can be selected in order to carry out a further optimization, in particular including at least one of the following steps: varying the speed, and recording the profile, calculating and validating the parameters L, checking for optimality, and/or varying the velocity again or accepting the solution. In addition, the dynamics of the scan system having a classic controller would have only limited use for a rapid variation of the scan speed.

An application for the present subject matter is, for example, creating bitmaps (a rasterized image having grayscale information) using a laser, for example, in particular for creating patterns on textiles or for generating a photo on a chipcard credential, as is described in the following. Preferably, the present subject matter is additionally or alternatively designed according to the following description, wherein the aforementioned features can be present individually or in any combination. Bitmaps consist of a plurality of pixels and are marked unidirectionally or bidirectionally line-by-line using laser scanners, in particular galvo scan systems. Typically, the line speed is held constant and the laser energy per pixel is varied according to the desired grayscale. The dynamics of the scan system are irrelevant for the image quality, since the acceleration phases are outside of the bitmap range. Tracking errors can be compensated for by an offset of the lines. In this way, high-resolution bitmaps can be precisely lasered.

In order to reduce process time and to increase productivity at a given laser power, the scan speed within a row can be adapted to the grayscale value profile. The necessary laser energy is determined on the basis of the grayscale value of the pixel; on the basis of this value, using the maximum available laser power, the maximum possible pixel speed at the location of the pixel can be calculated. A trajectory which has been optimized for time, i.e., a time-dependent position profile, can be determined for each row of pixels. Acceleration limits and jerk limits of the system must be taken into account. The velocity of the trajectory must be lower at each pixel position than the maximum possible pixel speed, which is calculated on the basis of the grayscale values; otherwise the grayscale value cannot be reached.

The laser power is optimally used when the maximum laser power is always used and the grayscale values are reached only via the scan speed. Grayscale values can arbitrarily vary from pixel to pixel, which would require a very high acceleration of the scan system. The problem is then that of determining a trajectory which is optimal with respect for time under the given boundary conditions. The possible time savings greatly depends on the grayscale value distribution of the bitmaps; the conditions are usually favorable when creating patterns in textiles.

A precontrol of the scanner controller is necessary in order to be able to exactly follow the calculated trajectory. This can be carried out using a scan system such as the SCANLAB excelliSCAN or offline. The laser control for the pixels must take place precisely at every pixel position. Due to the activation period of the laser and the pixel speed, the pixel expands beyond a certain length which is smaller than the pixel pitch. The laser control is carried out such that the pixels are centered on the desired pixel array.

In the following, the grayscale value of the pixel i within a row is designated with the value Gᵢ. The value range of G is between 0 and 1. Bitmap files normally use 8-bit grayscale values, i.e., the grayscale values must first be standardized to 1. A grayscale value of 0 corresponds to “white” and thus to the maximum laser energy. Depending on the method, however, an inverse relationship is also possible.

When a laser is used, in particular a CW laser diode, having a maximum power of Pₘₐₓ, the maximum pixel energy results as Eᵢ=Pₘₐₓ·D/vᵢ, wherein D is the pixel pitch and vᵢ is the velocity at the pixel i. This is only an approximation, since the velocity is not constant. Since the pixel pitch and the variation of the velocity from pixel to pixel are low, however, this approximation can be used.

Assuming a linear relationship between the grayscale value and the pixel energy, the maximum possible velocity vᵢ at the pixel i can be determined on the basis of this linear relationship. Eₘₐₓ is the pixel energy that is necessary for a grayscale value of 0. The actual velocity is generally lower and the grayscale value must be reached by reducing the laser power or briefly switching it off. A grayscale value of 1 would allow for an infinitely high velocity, which however is limited by dynamic limits, specifically, for example, such that only a pixel frequency of 100 kHz can be generated preferably by an RTC control card in the microvector mode: vₗᵢₘᵢₜ=D·100 kHz

Eᵢ=(1−Gᵢ)·Eₘₐₓ

$${v}_{i} = \frac{{P}_{max}}{{E}_{max}} \cdot \frac{D}{1 - {G}_{i}}$$

CO2 lasers can be used. These are actuated, for example, by a PWM signal in a frequency range of 0-100 kHz; typically, the pulse duty factor is not permitted to exceed a value of, for example, 55%. Due to the high time constant, in particular of approximately 60 μs, a non-linear relationship is to be assumed between the laser activation period and the pixel energy; for this reason, a correction, such as a gamma correction γ, is used.

The laser activation period LaserOnᵢ at the pixel i is calculated on the basis of this grayscale value and the maximum laser activation period of a white pixel.

LaserOnᵢ=(1−Gᵢ)^{γ}−LaserOnMax

With the maximum permissible pulse duty factor, the maximum pulse frequency is calculated, and with the pixel pitch, in turn, the maximum possible pixel speed is calculated.

$${v}_{i} = \frac{DutyCycleMax}{LaserOnMax} . \frac{D}{{( 1 - {G}_{i} )}^{γ}}$$

The trajectory can be calculated in an acceleration-limited and/or jerk-limited manner, so that they can also be carried out by the scan system. Since a trajectory planning of the third order is relatively complex and time-consuming, a simpler approach can be selected in many applications. First, a trajectory of the second order is calculated, then the jerk limitation is reached by means of a moving average. This method is substantially simpler and faster but does not yield the optimal solution.

The velocity planning can be carried out in the local region, i.e., according to the position.

$${a}_{max} = \frac{dv}{dt} = \frac{dv}{dx} \cdot \frac{dx}{dt} = \frac{dv}{dx} \cdot v$$

The maximum possible change in velocity between two adjacent pixels having the distance D can be determined by integration.

$${v}_{i + 1} = \sqrt{{v}_{i}^{2} + 2 \cdot D \cdot {a}_{max}}$$

Acceleration-limited velocity planning can be carried out very quickly using a one-time forward and backward planning along the row of pixels. In so doing, vᵢ₊₁ is determined and compared with the maximum possible pixel speed. When the velocity is permitted, it is used for these pixels; otherwise the maximum possible velocity is used.

The trajectory x(t) can then be easily calculated on the basis of the optimized position-dependent velocity profile across a row of pixels.

The maximum possible acceleration of the scan system for the trajectory planning within a row does not necessarily need to be used. A reduced value can suffice to achieve the desired increase in performance.

A sliding average can be applied to the trajectory when jerk must be limited. The averaging is carried out over 2·M+1 time increments; the index j indicates the position in 10 μs time increments. Jumps in acceleration are therefore distributed over 2·M+1 time increments and the jerk is limited.

$${\tilde{x}}_{j} = \frac{1}{2 \cdot M + 1} {\sum }_{k = - M}^{M} {x}_{j + k}$$

The averaging acts as a low pass filter on the pixel speed, as a result of which the velocity can increase at some positions and slightly exceed the maximum possible velocity. This can also be avoided by suitably refining the planning method.

In addition, overrun distances at the start and the end of the row must be added. The length results from the multiplication of the pixel speed at the first pixel and the last pixel by the overrun time of M·10 μs. The laser control signals for the pixels can then be determined on the basis of the trajectory, taking the signal transit times into account.

Jumps from the end of one row to the beginning of the next row should take place in a manner which is optimal with respect to time. The calculation can be carried out with the third order or the second order and an averaging filter. The start speeds and the end speeds of the pixel lines must be individually taken into account. In addition, the start positions and the end positions of the lines can vary. For time reasons, the lines are bidirectionally marked. Fast algorithms in commercial or freely available libraries are available for planning the jumps. Depending on the dynamic limits of the scan system and the available adjustment range of the power of the laser, the velocity may also need to be explicitly limited and not only implicitly limited via the grayscale values of the row of pixels.

An optimal planning of the paths, which has been adapted to the image content, can optionally also be carried out prior to the planning of the scanner and laser actuation along the lines of the bitmap, which is presented here. This can mean that lines of the image do not necessarily have the same length and also do not necessarily always have the same direction/orientation. The image can also be composed of multiple regions using a different machining strategy. These regions can also overlap or be meshed with one another. The method for planning the scanner movement and the laser actuation shown here can also be identically or similarly applied.

In order to avoid the situation in which the first pixels in the first row are missing due to the laser dynamics, the laser actuation should be suitably planned in order to bring the laser into a state at the beginning of a row that enables the beginning of the row to be reached in a timely manner.

The present subject matter also relates to a computer program which, when run by a computer unit, prompts the computer unit to carry out at least a portion of the method steps of the method for optimizing the time according to one or more of the method steps described in the preceding description and/or in the following description. The computer program can be stored, for example, in a memory in the computer unit and/or can be run by the computer unit. The computer unit can also be a computer.

The present subject matter also relates to a computer-readable storage medium including a computer program, wherein the computer program, when run on a computer, prompts the computer to carry out the method for optimizing the time according to one or more of the method steps described in the preceding description and/or in the following description. The computer-readable storage medium can be the aforementioned memory. The computer program can be designed according to one feature in the preceding description and/or the following description.

The present subject matter further relates to a laser machining device for laser machining an object using a laser for laser machining. The laser can be generated by a laser unit.

The laser machining device also includes a galvo scan system for guiding a laser over the object.

The laser machining device also includes the computer unit, which computer unit is designed to carry out the method according to at least one of the method steps describing the preceding description and/or the following description.

One possible calculation for the time-optimized passage through or machining of the machining path on the object is presented in the following.

The geometric path p is defined by

$$p ( s ) = [ \begin{matrix}x ( s ) \\ y ( s ) \\ z ( s )\end{matrix} ] , p ( s ) ∈ {C}^{2} ( D )$$

wherein x(s), y(s), z(s) are the path coordinates relative to the previous arc length s∈[0,L].

The vectorial velocity, acceleration, and jerk can be expressed as follows.

v=p′\dot{s}

a=p′\ddot{s}+p″\dot{s}²

j=p [symbol] +p″\dot{s}\ddot{s}+p′″\dot{s}³

wherein

$$\dot{s} = \frac{ds}{dt} , {p}^{′} = \frac{dp}{ds}$$

defines the optimization problem by maximizing the velocity.

$$maximize {\int }_{0}^{L} \dot{s} ds$$

The solution is limited by the maximum reachable velocity, acceleration, and jerk.

vₘₐₓ≥|p′\dot{s}|

aₘₐₓ≥|p′\ddot{s}+p″\dot{s}²|

jₘₐₓ≥|p′ [symbol] +p″\dot{s}\ddot{s}+p′″\dot{s}³|

Since t is unknown and, therefore, \dot{s}, \ddot{s} and [symbol] cannot be explicitly calculated, a substitution is carried out. For \dot{s}=\sqrt{q}, this yields

$${v}_{max} \geq \vert {p}^{′} \vert \sqrt{q}$$

$${a}_{max} \geq \vert \frac{1}{2} {p}^{′} {q}^{′} + {p}^{″} q \vert$$

$${j}_{max} \geq \vert \frac{1}{2} {p}^{′} {q}^{″} + \frac{3}{2} {p}^{″} {q}^{′} + {p}^{′′′} q \vert \sqrt{q}$$

By definition, \dot{s} and thus q are positive definite. If q is then defined as a B-spline of the second order, the derivatives q′, q″ can be considered to be linear over the support points [a₁, a₂ . . . a_{K}] of the spline,

$$q ( s ) = {\sum }_{i = 1}^{K} {N}_{i , 2} ( s ) \cdot {a}_{i} ,$$

$${q}^{′} ( s ) = {\sum }_{i = 1}^{K} {N}_{i , 2}^{′} ( s ) \cdot {a}_{i} ,$$

$${q}^{″} ( s ) = {\sum }_{i = 1}^{K} {N}_{i , 2}^{″} ( s ) \cdot {a}_{i}$$

wherein N_{i,2}(s) are the basic functions of the spline. These are determined by means of De Boor's algorithm.

The support points [a₁, a₂ . . . a_{K}] are now the optimization parameters. In order to completely linearize the optimization task, an approximation for must be found. To this end, the optimization problem is solved without a jerk limitation. The q* determined as a result is an upper limit of all reachable jerk-limited trajectories. The solution space of the task can only be smaller than or equal to the already determined q* due to an additional condition (jerk). The condition can be introduced as a pseudo jerk by means of this approximation in the second optimization step.

$${\tilde{J}}_{max} \geq \vert \frac{1}{2} {p}^{′} {q}^{″} + \frac{3}{2} {p}^{″} {q}^{′} + {p}^{′′′} q \vert \sqrt{{q}^{*}}$$

Since q*≥q applies, so does jₘₐₓ≥\tilde{j}ₘₐₓ

Two necessary steps for determining the jerk-limited trajectory therefore result:

### Step 1:

$$maximize {\int }_{0}^{L} \dot{s} ds with$$

$${v}_{max} \geq \vert {p}^{′} \vert \sqrt{q *}$$

$${a}_{max} \geq \vert \frac{1}{2} {p}^{′} {q}^{* ′} + {p}^{″} q * \vert$$

### Step 2:

$$maximize {\int }_{0}^{L} \dot{s} ds with$$

$${v}_{max} \geq \vert {p}^{′} \vert \sqrt{q}$$

$${a}_{max} \geq \vert \frac{1}{2} {p}^{′} {q}^{′} + {p}^{″} q \vert$$

$${\tilde{J}}_{max} \geq \vert \frac{1}{2} {p}^{′} {q}^{″} + \frac{3}{2} {p}^{″} {q}^{′} + {p}^{′′′} q \vert \sqrt{{q}^{*}}$$

By using the matrix representation of the B spline

$$[ \begin{matrix}{q}_{1} \\ ⋮ \\ {q}_{K}\end{matrix} ] = [ \begin{matrix}{N}_{1 , 2} ( {s}_{1} ) & … & {N}_{K , 2} ( {s}_{1} ) \\ ⋮ & ⋱ & ⋮ \\ {N}_{1 , 2} ( {s}_{k} ) & … & {N}_{K , 2} ( {s}_{K} )\end{matrix} ] [ \begin{matrix}{a}_{1} \\ ⋮ \\ {a}_{K}\end{matrix} ]$$

effective LP solvers can be used. Due to this representation, an explicit v_{max,i} can then also be predefined for each path parameter s.

$$[ \begin{matrix}{v}_{max , 1}^{2} \\ ⋮ \\ {v}_{max , K}^{2}\end{matrix} ] \geq {\vert {p}^{′} \vert}^{2} [ \begin{matrix}{N}_{1 , 2} ( {s}_{1} ) & … & {N}_{K , 2} ( {s}_{1} ) \\ ⋮ & ⋱ & ⋮ \\ {N}_{1 , 2} ( {s}_{k} ) & … & {N}_{K , 2} ( {s}_{K} )\end{matrix} ] [ \begin{matrix}{a}_{1} \\ ⋮ \\ {a}_{K}\end{matrix} ]$$

### BRIEF DESCRIPTION OF THE FIGURES

Further advantages of the invention are described in the following exemplary embodiments. Wherein:

FIG. 1 shows a machining of an object 1 by a laser 2 along a machining path 4 by means of a galvo scan system 3,

FIG. 2 shows examples of a location-dependent energy input profile E(s) and of a location-dependent idealized velocity profile v(s) and of a reachable velocity profile v(s), and

FIG. 3 shows an alternative example of a location-dependent energy input profile E(s) and of a location-dependent idealized velocity profile v(s) and of a reachable velocity profile v(s).

### DETAILED DESCRIPTION

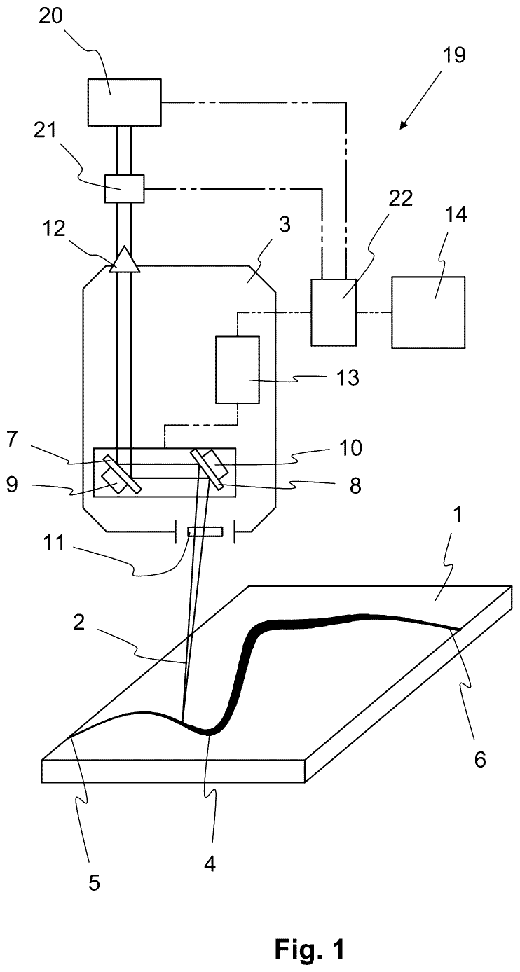

FIG. 1 shows a laser machining of an object 1 by a laser 2 along a machining path 4 by means of a laser machining device 19. The laser source 20 generates a laser beam (referred to in the following as “laser.”) The laser 2 is guided over the object 1 and along the machining path 4 by a galvo scan system 3. In the following, it is explained that the laser 2 is moved over the object 1. For this purpose, a beam of the laser 2, or a laser beam, or a laser focus of the laser 2 is moved over the object 1 and along the machining path 4.

The machining path 4 has, according to the present exemplary embodiment, a path start 5 and a path end 6. The laser 2 therefore passes over the machining path 4, or the path 4, from the path start 5 to the path end 6. In particular, the laser 2 begins machining the object 1 at the path start 5 and terminates the machining of the object 1 at the path end 6.

Galvo scan system 3 means, in this case, that the galvo scan system 3 has at least one, in particular at least two galvanometer drive(s) 9, 10, which are described in greater detail in the following. Galvo is the abbreviation for galvanometer drive here and in the following.

The galvo scan system 3 in this exemplary embodiment has two deflection mirrors 7, 8 in order to direct the laser 2 onto the object 1 and in order to be able to move the laser 2. By means of the two deflection mirrors 7, 8, the laser 2 can be moved over the object 1 in a planar manner. For example, the laser 2 can be moved in one direction by means of one first deflection mirror 7, whereas the laser 2 can be moved in a direction oriented transversely thereto by one second deflection mirror 8. In all, the laser 2 can thereby be moved over the object 1.

The laser beam can be optionally focused onto the plane of the workpiece, as shown in this example, by means of an optical scanning unit 11 located in the beam path downstream from the deflection mirrors 7, 8. For this purpose, in particular, an f-theta lens can be used, in which the position of the focus in the plane substantially linearly depends on the deflection angles of the two deflection mirrors.

In order to be able to move both deflection mirrors 7, 8, one galvanometer drive 9, 10, or one galvo 9, 10, is associated with each deflection mirror 7, 8. The first deflection mirror 7 can be moved by means of one first galvanometer drive 9 and the second deflection mirror 8 can be moved by means of the one second galvanometer drive 10.

The galvo scan system 3 receives position data p(t) from the controller 22, which position data represents the coordinates of the machining path 4 on the object 1. The machining path 4 is determined by means of the position data p(t). This position data p(t) is used for the open-loop control of the galvanometer drives 9, 10 in order to specify a target position of the deflection mirrors 7, 8 at the points in time t. The position of the deflection mirrors 7, 8 still depends on the orientation and/or position of the galvo scan system 3 with respect to the object 1. The position data p(t) is also determined in the form p(t)=p(s(t)) by means of a time-dependent path progress s(t). The calculation of the time-dependent path progress s(t) is described in the following and/or is explained in the preceding description.

The laser machining system (NR) also includes a focusing unit 21 by means of which the divergence of the laser beam 2 can be varied. As a result, a machining of the object 1 is possible not only in the width and the length, but also in the depth. In addition, the laser 2 can also be widened by means of the focusing unit 21, so that the laser 2 machines the object 1 not only at one point or in a relatively small area, but also in a correspondingly larger area due to the widening. The laser 2 can therefore be defocused. As is shown here, the focusing unit 21 is located downstream from the laser source 20 and/or spaced apart from the galvo scan system 3. As is apparent here, the focusing unit 21 is located upstream from a laser coupling 12, as is explained in the following. Optionally, the focusing unit 21 can also be an integral part of the galvo scan system 3.

The galvo scan system 3 also includes a laser coupling 12. The laser 2 can be generated at a remote location and, in order to be guided over the object 1, coupled into the galvo scan system 3. Alternatively, it is possible that the laser 2 is also generated directly in or at the galvo scan system 3. The laser source 20 shown here can therefore also be an integral part of the galvo scan system 3.

The laser machining device 19 includes the controller 22, which is arranged outside the galvo scan system 3 in this example, but which can optionally also be integrated into the galvo scan system 3 and, in particular, into the galvo control unit 13. The controller 22 can also be integrated into the computer unit 14. The controller 22 used in the computer unit 14 is, for example, a SCANLAB RTC6 PCI plug-in card, or a SCANLAB RTC6 ethernet box which is connected to the computer unit 14 via an ethernet connection.

The controller 22 can advantageously actuate the laser source 20 such that the laser power can be adapted. The controller 22 can be connected to a means for modulating the laser power, which means can be arranged in the laser source 20 in this example. The means can be, for example, an acousto-optic modulator or the modulation of the current of a laser diode. The controller 22 is also connected to the galvo scan system 3 in order to transmit the position data p(t) to the galvo control unit 13. Optionally, the controller 22 can also be connected to the focusing unit 21 in order to vary the focus of the laser 2.

The galvo scan system 3 according to the present exemplary embodiment also includes the galvo control unit 13, which controls the galvo scan system 3 and thus the movement of the laser 2. In particular, the galvo control unit 13 can control the angular position of the two galvos 9, 10, or the two galvanometer drives 9, 10, so that the two deflection mirrors 7, 8 are moved according to the target position profile and guide the laser 2 along the machining path 4. In order to follow the machining path 4 as precisely as possible, a control method is preferably implemented in the galvo control unit 13, which control method does not have a tracking error, in particular a status controller or a trajectory controller. The control method can presuppose that the target position profile has dynamic limits, in particular for velocity and/or acceleration and/or jerk, which correspond to the physical limits of the galvanometer drives 7, 8 and/or to the limits of the power supply of the galvanometer drives. These dynamic limits can also be more narrowly defined than the corresponding physical limits, for example, to improve the stability of the control algorithm.

As is shown here, the machining path 4 has a varying thickness. The thickness is intended to represent an energy input E into the object 1 along the machining path 4. Thicker points on the machining path 4 are intended to represent a high energy input E, whereas thinner points represent a correspondingly low energy input E. The energy input E is also the energy which the laser 2 introduces into the object 1 along the machining path 4. The energy input E depends on the laser power L of the laser 2. A high laser power L results in a high energy input E and a low laser power L results in a low energy input E. The energy input E also depends on time. The longer the laser 2 is located at a point on the machining path 4 or in a region along the machining path 4, the more energy is introduced.

The object 1 can be, for example, engraved, ablated, marked, cut, and/or welded by means of the energy input E, or by means of the laser 2. The object 1 is also correspondingly machined according to the energy input E by the laser 2 at a certain point or in a certain region. For example, by means of a low energy input E, for example in the region of the path start 5, the object can be machined such that the properties of the object 1 change only slightly at this point. If, for example, material is to be removed, only a small amount of material is removed by means of the low energy input E, as is shown here at the path start 5. In a middle region of the machining path 4, at which the machining path 4 is shown thicker in this case, more energy is input, or the energy input E is higher, in comparison to the path start 5. Consequently, the object 1 is more heavily machined here, providing, of course, that the object 1 has correspondingly constant properties or, for example, along the machining path 4 shown here, is made of the same material. If material is removed again, the higher energy input E results in more material being removed or the properties of the object 1 being changed to a greater extent at the point of the higher energy input E. As mentioned above, it is intended to be presupposed here, for a simpler explanation, that the object 1 has constant properties overall.

The machining of the object 1 along the machining path 4 therefore depends on the energy input E along the machining path 4. In addition, the machining of the object 1 also depends on other factors such as material, etc., which are not yet taken into account here, however. Nevertheless, such factors can be taken into account in the method described in the following and/or in the method described in the preceding description.

As another example, the object 1 can be a textile material into which a pattern is to be applied. By means of the laser 2, a textile piece, in particular a dyed textile piece, can be bleached along the machining path 4. Dyes can be destroyed by the energy input E by the laser 2, so that the textile piece becomes lighter at these points. As a result, a pattern can be applied via the energy input E along the machining path 4. By varying the energy input E along the machining path 4, various levels of bleaching can therefore be achieved, so that the textile piece becomes correspondingly lighter or darker (in relation to the color of the textile piece) along the machining path 4. If the machining path 4 is planned accordingly, various two-dimensional patterns or, for example, letters, can also be formed.

Since this can be an industrial machining of the object 1, it is advantageous when the machining of the object 1 by the laser 2, i.e., a laser machining of the object 1, is carried out as quickly as possible. To this end, the present subject matter relates to a method, in particular to a computer-implemented method, for optimizing the time of laser machining of the object 1, in which the laser 2 can be guided along the predefined machining path 4 on the object 1 by a galvo scan system 3.

As described above, the object 1 can be a textile piece or a workpiece in general. Additionally or alternatively, the object 1 can also be a body part, so that the laser machining is used for medical purposes.

The computer unit 14 is shown here, with which the method explained in the preceding description and/or the method explained in the following description can be carried out. The control data gathered using the method can be transmitted from the computer unit 14 to the controller 22. The controller 22 then synchronously controls at least the modulation of the laser power and the position of the laser 2.

A laser machining device 19 is also shown at least in part. The laser machining device 19 includes the laser 2, or the laser source 20 with which the laser 2 is generated, the focusing unit 21, the galvo scan system 3, the computer unit 14, and preferably the controller 22.

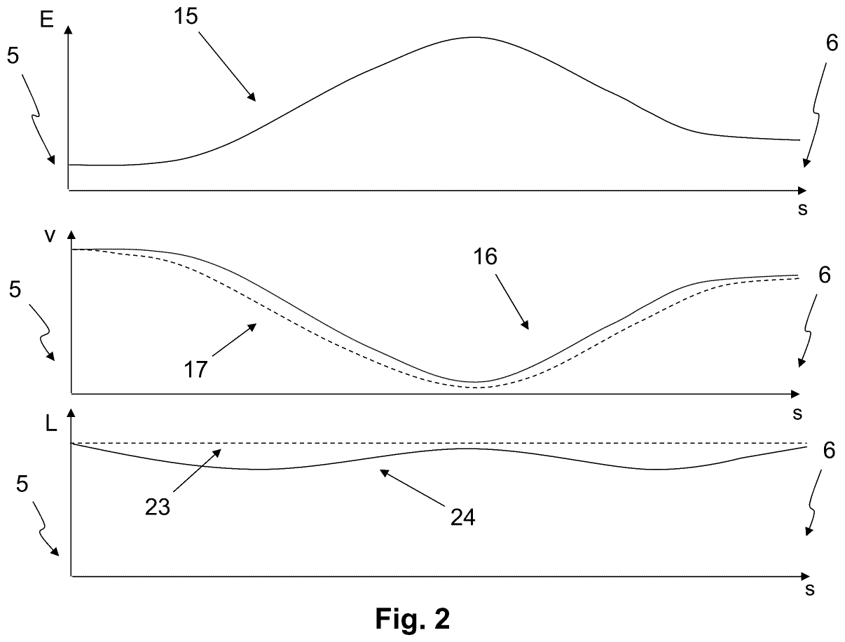

FIG. 2 shows examples of a location-dependent energy input profile E(s) 15, of a location-dependent idealized velocity profile v(s) 16, and of power profiles 23, 24.

FIG. 2 shows three diagrams, or coordinate systems. In both coordinate systems, the x-axis indicates a location s or a point along the machining path 4. In the first, upper diagram, or coordinate system, the energy, or the energy input E, is plotted on the y-axis. In the second, lower diagram, or coordinate system, the velocity v is plotted on the y-axis.

The location-dependent energy input profile E(s) 15 indicates how high the energy input must be at a location s on the machining path 4. It is to be noted here that the location-dependent energy input profile E(s) 15 shown in FIG. 2 is based on the machining path 4 shown in FIG. 1. The location-dependent energy input profile E(s) 15, as well as the location-dependent idealized velocity profile v(s) 16, also begins at the path start 5 and ends at the path end 6. If the location s in the diagram, or coordinate system, is therefore passed through from the path start 5 to the path end 6, the machining path 4 is also passed through from the path start 5 to the path end 6.

Since the location-dependent energy input profile E(s) 15 shown in FIG. 2 is based on the machining path 4 shown in FIG. 1, the location-dependent energy input profile E(s) 15 increases from the path start 5 up to a middle region. This is shown in FIG. 1 by the machining path 4 becoming wider. Thereafter, the location-dependent energy input profile E(s) 15 drops again, which is shown in FIG. 1 by the machining path 4 becoming thinner.

The location-dependent energy input profile E(s) 15 is advantageously predefined. This means that the location-dependent energy input profile E(s) 15 is present as input data. The location-dependent energy input profile E(s) 15 can advantageously also be determined from a specified value or from a location-dependent specified-value profile. For example, a customer provides an ablating profile along the machining path 4 as a specified-value profile, which ablating profile specifies how much material is to be removed along the machining path 4. The specified-value profile that is predefined can also be a bleaching profile which indicates the extent to which the textile piece is to be bleached along the machining path 4. The location-dependent energy input profile E(s) 15 can be determined from this specified-value profile, wherein material properties are preferably taken into account. It is clear that different energy inputs are necessary for plastic and metal, for example, iron or steel, in order to achieve comparable material removal.

Preferably, the energy input E into the object 1 in a region along the machining path 4 is determined from the location-dependent energy input profile E(s) 15 by integrating the location-dependent energy input profile E(s) 15 in the corresponding range in the diagram.

In order to machine the machining path 4 in a time-optimized manner, it is advantageous when the laser 2 is moved through the machining path 4 as fast as possible. The greatest possible velocity of the laser 2 along the machining path 4 is limited by the fact that the location-dependent energy input profile E(s) 15 must be achieved. In addition, the laser 2 has only limited laser power.

In the method, a location-dependent first power profile L₁(s) 23 of the laser 2 along the machining path 4 is defined. The location-dependent first power profile L₁(s) 23 is always smaller than or equal to the maximum possible power of the laser 2. Advantageously, the location-dependent first power profile L₁(s) 23 is defined to be as high as possible, so that the machining time of the machining path 4 is shortened, in particular being constant and equal to the available maximum power that the laser source 20 can generate. It is advantageous when the location-dependent first power profile L₁(s) 23 is defined to be constant at least in sections, as is shown here. The location-dependent idealized velocity profile vₘₐₓ(s) 16 is calculated on the basis of the location-dependent first power profile L₁(s) 23 and the location-dependent energy input profile E(s) 15. A possible relationship between the location-dependent idealized velocity profile vₘₐₓ(s) 16, the location-dependent first power profile L₁(s) 23, and the location-dependent energy input profile E(s) 15 can be, for example, as follows:

$$vmax ( s ) ∼ \frac{L 1 ( s )}{E ( s )}$$

The idealized velocity at the location s can be, in particular, proportional to the ratio of the location-dependent power profile L₁ and the desired energy input E at the location s. Another relationship, in particular a non-linear relationship, between power L, energy E, and velocity v can also apply for the laser process, however. For the method according to the present subject matter, it is only important that there is a value range in which a velocity v can be associated with an energy input E and a power L via a known relationship. Further parameters such as a focus spot size or an angle of incidence of the laser 2 can also be incorporated into this relationship. This relationship can be determined, for example, from experimental parameter studies in which the laser machining is carried out at least with multiple various values of the parameters power and velocity, and the energy input (i.e., for example, the ablation or the color change) is evaluated. The values determined this way via experimentation can be summarized in a value table and interpolation can be carried out between the values in this table. The value table or a suitable representation of the interpolation is stored in the computer unit 14 and allows for one of the three variables velocity v, power L, and/or energy input E to be calculated when the other two variables are given. Since the dependence of the energy input E on the parameters velocity v and power L generally has a strictly monotonous profile in each case, the aforementioned calculation of the variables is generally clearly possible. If the relationship for various further parameters of the laser process is similarly determined via experimentation, the influence of these parameters can also be taken into account in the method. For example, the influence of the angle of incidence on the object surface or the influence of a defocusing of the laser beam can also be stored in the value table.

The location-dependent idealized velocity profile vₘₐₓ(s) 16 is shown in FIG. 2 in the diagram, or coordinate system, in the middle. As is apparent, the location-dependent idealized velocity profile vₘₐₓ(s) 16 is comparatively low in the central region. The location-dependent idealized velocity profile vₘₐₓ(s) 16 is low in the central region for the following reason. The location-dependent energy input profile E(s) 15 is high in the central region, which corresponds, for example, to the wide, central region of the machining path 4 shown in FIG. 1. A comparatively high energy input E into the machining path 4 is therefore intended to take place here. Since the laser power L, or the location-dependent first power profile L₁(s) 23, cannot be arbitrarily high, or is limited, however, the location-dependent idealized velocity profile vₘₐₓ(s) 16 must be lower in this region, so that the high energy input E can be achieved. The laser 2 must move correspondingly slowly along the machining path 4 here. At the path start 5 and at the path end 6, the location-dependent idealized velocity profile vₘₐₓ(s) 16 is higher, however, since the location-dependent energy input profile E(s) 15 is lower here. The machining path 4 can be passed through faster by the laser 2 here, while the predefined energy input E is still achieved. “Idealized” with respect to the location-dependent idealized velocity profile vₘₐₓ(s) 16 here means that this is the maximum velocity vₘₐₓ that the laser 2 can have along the machining path 4 depending on the location s, so that, in consideration of the location-dependent first power profile L₁(s) 23, the location-dependent energy input profile E(s) 15 is just reached.

In the method, a time-dependent path progress s(t) is also calculated such that a reachable velocity profile v(s) 17 of the laser 2 along the machining path 4 is limited by the location-dependent idealized velocity profile vₘₐₓ(s) 16, and at least one dynamic limit of the galvo scan system 3 is adhered to along the machining path 4. The at least one dynamic limit results from the fact that the deflection mirrors 7, 8 cannot be arbitrarily quickly moved and/or the orientation of the deflection mirror cannot be arbitrarily quickly changed. In particular, the galvanometer drives 9, 10 also have inertia, so that the laser 2, for example, cannot be arbitrarily quickly accelerated in order to achieve the idealized velocity profile vₘₐₓ(s) 16. The at least one dynamic limit can therefore be an acceleration limit and/or a jerk limit of the galvo scan system 3, in particular of the deflection mirrors 7, 8 and/or of the galvanometer drives 9, 10.

The idealized velocity profile vₘₐₓ(s) 16 is therefore the most that can be achieved from the reachable velocity profile v(s) 17. The reachable velocity profile v(s) 17 is therefore limited by the idealized velocity profile vₘₐₓ(s) 16.

In order to reach the reachable velocity profile v(s) 17, the method calls for calculating the time-dependent path progress s(t). The time-dependent path progress s(t) indicates the point in time at which the laser 2 has progressed how far along the machining path 4. The time-dependent path progress s(t) therefore indicates the location s at which the laser 2 is located at which time t.

The time-dependent path progress s(t) is advantageously calculated by means of an optimization method, so that a passage time of the laser 2 through the machining path 4, or a machining time of the machining path 4, is minimal. Additionally or alternatively, the time-dependent path progress s(t) can be calculated using the optimization method such that the reachable velocity profile v(s) 17 becomes maximum at least in sections, in particular overall.

In the diagram shown in the middle in FIG. 2, an exemplified reachable velocity profile v(s) 17 is shown as a dashed line. It is apparent that the reachable velocity profile v(s) 17 is limited by the location-dependent idealized velocity profile vₘₐₓ(s) 16. The two profiles 16, 17 can be at least approximately identical at least in the region of the path start 5 shown here, for example, since the laser 2 has already been accelerated in a run-up. It is to be noted, however, that the reachable velocity profile v(s) 17 can very well approximate the location-dependent idealized velocity profile vₘₐₓ(s) 16 when, for example, a straight machining path 4 has a constant energy input E, so that the laser power L and/or the velocity v does not need to be changed. In this exemplified case, the reachable velocity profile v(s) 17 can approximate the location-dependent idealized velocity profile vₘₐₓ(s) 16.

In the method, a time-dependent second power profile L₂(s(t)) 24 is also calculated, wherein the location-dependent first power profile L₁(s) 23 is reduced such that the location-dependent energy input profile E(s) 15 is achieved at points or locations s on the machining path (4), at which the reachable velocity profile v(s) 17 is lower than the idealized location-dependent velocity profile vₘₐₓ(s) 16. Since the reachable velocity profile v(s) 17 is lower than the location-dependent idealized velocity profile vₘₐₓ(s) 16, the laser 2 also dwells in a region of the machining path 4 for a longer time, so that, when the location-dependent first power profile L₁(s) 23 is adhered to, the energy input E becomes too great, in particular exceeding the specification. In order to thereby compensate for the lowering of the reachable velocity profile v(s) 17 relative to the location-dependent idealized velocity profile vₘₐₓ(s) 16, the location-dependent first power profile L₁(s) 23 is reduced to the time-dependent second power profile L₂(s(t)) 24. A relationship between the reachable velocity profile v(s) 17, the location-dependent energy input profile E(s) 15 to be achieved, and the time-dependent second power profile L₂(s(t)) 24 can be, for example, as follows:

L₂(s(t))~E(s)*v(s)

The time-dependent path progress s(t) can be defined as a standardized path progress, i.e., s(t) represents the length of the path that has been covered on the path up to the point in time t. The time-dependent path progress s(t) is therefore clearly invertible into a t(s). This then yields:

$$v ( t ) = \frac{ds ( t )}{dt}$$

Using the inverse function t(s), v(s) can be determined as v(s)=v(t(s)).

The two power profiles 23, 24 are shown in the lower diagram. As is apparent, the location-dependent first power profile L₁(s) 23 is greater than or equal to the time-dependent second power profile L₂(s(t)) 24. It is also apparent that the second power profile L₂(s(t)) 24 is reduced to a greater extent relative to the power profile L₁(s) 23 at the locations at which the reachable velocity profile 17 deviates farther downward from the idealized velocity profile 16. Moreover, it is apparent that the second power profile L₂(s(t)) 24 lies only slightly underneath the first power profile L₁(s) 23 along the entire machining path 4. It is apparent here that, due to the optimization, the available power of the laser can be utilized to a great extent in the process.

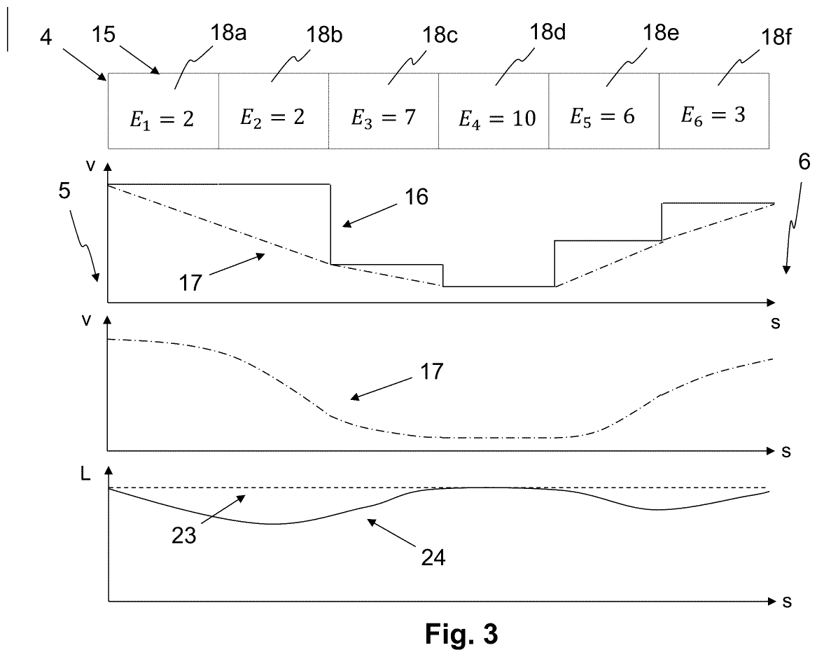

FIG. 3 shows an example of a machining path 4 which has a discrete location-dependent energy input profile E(s) 15. Six boxes are shown in the upper region of FIG. 3, which boxes are exemplified path sections 18 along the machining path 4. The fact that the machining path 4 has only six path sections 18 is merely a simplification for the purpose of explanation. A machining path 4 can include considerably more path sections 18, for example, up to tens of thousands or more, since a path section 18 can have a size of a few μm. Due to such a number of path sections 18, the discrete location-dependent energy input profile E(s) shown here yields an approximately continuous location-dependent energy input profile E(s) 15, so that functions can be expected to be continuous.

The location-dependent energy input profile E(s) 15 can originate, for example, from a specified-value profile for grayscale values. Each path section 18 can be associated with a grayscale value which represents a shade, for example, on a textile piece. The location-dependent energy input profile E(s) 15 can be determined by means of the specified-value profile, or on the basis of the grayscale value for each path section, so that the associated shade is obtained on the textile piece. For example, the energy input E must be higher when more dye must be dissolved, so that the textile piece becomes lighter at this point.

The boxes, or path sections 18, shown here can be compared with pixels in a bitmap or can originate from this bitmap.

Each path section 18 is associated with an energy input E here, which energy input can be determined by reference to the location-dependent energy input profile E(s) 15. The first path section 18a has the first energy input E₁=2. The second path section 18b has the second energy input E₂=2. The third path section 18c has the third energy input E₃=7. The fourth path section 18d has the fourth energy input E₄=10. The fifth path section 18e has the fifth energy input E₅=6. The sixth path section 18f has the sixth energy input E₆=3. This location-dependent energy input profile E(s) 15 is therefore approximately similar to that shown in FIGS. 1 and 2. This location-dependent energy input profile E(s) 15 shown here is predefined, or determined from a specified-value profile.

The location-dependent idealized velocity profile vₘₐₓ(s) 16 is determined on the basis of the location-dependent energy input profile E(s) 15 and of the location-dependent first power profile L₁(s) 23. Since the location-dependent energy input profile E(s) 15 is discrete, i.e., constant along the particular path sections 18, the location-dependent idealized velocity profile vₘₐₓ(s) 16 is also constant in sections, specifically in the particular path sections 18. The location-dependent idealized velocity profile vₘₐₓ(s) 16, as well as the location-dependent energy input profile E(s) 15, are staircase-shaped, or are a step function, in this case. The reachable velocity profile v(s) 17 is shown by the dash-dotted line. This is calculated here such that it is linear in the particular path sections 18, the variation over time of the velocity v being limited here by a dynamic limit of the galvo scan system 3, specifically, in particular, an acceleration limit in the example. This is calculated, in addition, such that it is limited by the location-dependent idealized velocity profile vₘₐₓ(s) 16. Moreover, it is apparent that the reachable velocity profile v(s) 17 and the location-dependent idealized velocity profile vₘₐₓ(s) 16 are identical in the fourth path section 18d, wherein the reachable velocity profile v(s) 17 is still limited by the location-dependent idealized velocity profile vₘₐₓ(s) 16.

The limitation of the acceleration is apparent in the first two path sections 18a, 18b in the example shown in FIG. 3. The reachable velocity profile v(s) 17 does not follow the idealized velocity profile vₘₐₓ(s) 16 in the first path section 18a, otherwise the absolute value of the necessary acceleration would exceed the acceleration limit of the galvo scan system 3 in the region of the second path section 18b, or the idealized velocity profile vₘₐₓ(s) 16 would be exceeded in the third path section 18c, even if the maximum available acceleration in the second path section 18b were used. In order to avoid this, in the method, a variable velocity v is selected already in the first path section 18a in order to distribute the entire velocity change Δv required up to the beginning of the third path section 18c across the first two path sections 18a, 18b. If this would not suffice (as shown in this example) in order to adhere to the acceleration limit, then, in the method, the velocity v would have to be selected to be lower than the idealized velocity vₘₐₓ(s) 16 already at the beginning of the first path section 18a, in order to be able to determine a reachable velocity profile v(s) 17.

Since the reachable velocity profile v(s) 17 is lower than the location-dependent idealized velocity profile vₘₐₓ(s) 16 at least in sections, the location-dependent first power profile L₁(s) 23 is reduced, wherein the time-dependent second power profile L₂(s(t)) 24 is calculated, so that the energy input profile E(s) is achieved, or so that the energy inputs E in the particular path sections 18 are achieved and, in particular, are not exceeded. A constant energy input E can also be calculated for each of the path sections 18, in particular for very short path sections 18, from a mean velocity v of the path section 18, which corresponds to the energy input E of the path section 18 averaged over time.

The reachable velocity profile v(s) 17 is shown once more in the third diagram, although being smoothed in this case. This has the advantage that the reachable velocity profile v(s) 17 has no sharp edges, so that the velocity v does not abruptly change. Due to this smoothing, the jerk, which corresponds to the time derivative of the acceleration, is also limited to a finite value. Due to a suitable selection of the parameters of the smoothing, a further dynamic limit of the galvo scan system 3, specifically a jerk limit, can be adhered to.

On the basis of path progress s(t) determined using this method, the actuation data p(t)=p(s(t) for the galvo scan system 3 and L₂ (t)=L₂ (s(t)) for the modulation of the laser power L are determined, which can be transmitted from the computer unit 14 to the controller 22.

In the calculation, the same relationship between the process variables energy input E, velocity v, and power L can be used that was described above in the context of calculating the idealized velocity vₘₐₓ(s) 16.

For the purpose of the implementation by the controller 22, this data can optionally also be interpolated or scaled by the controller 22 or the computer unit 14 in order to correspond to the timing of the controller 22 and/or to the internal coordinate system of the galvo scan system 3. For example, the controller 22 can transmit two digital values to the galvo scan system 3 once every 10 μs, which digital values have a 20 bit resolution and describe the target angular position of the galvanometer drives 7, 8 and synchronously modulate the power of the laser 2 with a higher clock speed of, for example, 8 MHz or 64 MHz. The actuation of the laser modulation can be carried out by the controller 22, for example, also with an analog signal which is obtained from a digital signal which the controller 22 generates on the basis of the time-dependent second power profile L₂ (t).

The controller 22 can also digitally modulate the laser source 20 between two powers, in particular also switch the laser source on and off. The controller 22 can actuate the laser source 20, for example, with a pulse-width modulated signal with which the time-dependent second power profile L₂ (t) 24 is formed. Due to the pulse duty factor, a mean laser power can be set, which corresponds to the time-dependent second power profile L₂ (t).

In the lower diagram, the two power profiles L₁(s) 23, L₂(s(t)) 24 are shown once again. It is apparent here once again that, in the regions in which the reachable velocity profile v(s) 17 deviates from the idealized velocity profile vₘₐₓ(s) 16 to a greater extent, the second power profile L₂(s(t)) 24 is reduced to a greater extent relative to the location-dependent first power profile L₁(s) 23. For example, in the fourth path section 18d, the time-dependent second power profile L₂(s(t)) 24 and the location-dependent first power profile L₁(s) 23 are identical, since the reachable velocity profile v(s) 17 and the idealized velocity profile vₘₐₓ(s) 16 are identical. In the first and the second path sections 18a, 18b, the time-dependent second power profile L₂(s(t)) 24 deviates from the location-dependent first power profile L₁(s) 23 to a relatively great extent, since the reachable velocity profile v(s) 17 also deviates from the idealized velocity profile vₘₐₓ(s) 16 to a great extent. The deviation is less in the fifth and the sixth path sections 18e, 18f. The reduction of the second power profile L₂(s(t)) 24 relative to the location-dependent first power profile L₁(s) 23 can depend on the location-dependent difference between the reachable velocity profile v(s) 17 and the idealized velocity profile vₘₐₓ(s) 16.

The present subject matter is not limited to the exemplary embodiments which have been shown and described. Modifications within the scope of the claims are also possible, as is any combination of the features, even if they are represented and described in different exemplary embodiments.

### LIST OF REFERENCE CHARACTERS

1 object
2 laser
3 galvo scan system
4 machining path
5 path start
6 path end
7 first deflection mirror
8 second deflection mirror
9 first galvanometer drive
10 second galvanometer drive
11 optical scanning unit
12 laser coupling
13 galvo control unit
14 computer unit
15 location-dependent energy input profile E(s)
16 location-dependent idealized velocity profile vₘₐₓ(s)
17 reachable velocity profile v(s)
18 path section s(t)
19 laser machining device
20 laser source
21 focusing unit
22 controller
23 location-dependent first power profile L₁(s)
24 time-dependent second power profile L₂(s(t))
s location
E energy input
v velocity
t time

1-16. (canceled)

17. A computer-implemented method for optimizing the time of laser machining of an object, in which a laser can be guided along a predefined machining path on the object by a galvo scan system, the method comprises:
determining, with one or more computer units, a location-dependent energy input profile E(s) for energy input by the laser into the object along the machining path;
determining, with the one or more computer units, a location-dependent first power profile L₁(s) of the laser along the machining path;
determining, with the one or more computer units, a location-dependent idealized velocity profile vₘₐₓ(s) on the basis of the location-dependent first power profile L₁(s) and the location-dependent energy input profile E(s);
determining, with the one or more computer units, a time-dependent path progress s(t) such that a reachable velocity profile v(s) of the laser along the machining path is limited by the location-dependent idealized velocity profile vₘₐₓ(s) and at least one dynamic limit of the galvo scan system is adhered to along the machining path; and
determining, with the one or more computer units, a time-dependent second power profile L₂(s(t)), wherein the location-dependent first power profile L₁(s) is reduced such that the location-dependent energy input profile E(s) is achieved at a location(s) on the machining path at which the reachable velocity profile v(s) is lower than the location-dependent idealized velocity profile vₘₐₓ(s).

18. The method of claim 17, wherein determining the time-dependent path progress s(t) comprises determining the time-dependent path progress s(t) such that a machining time of the machining path is minimized.

19. The method of claim 17, wherein determining the time-dependent path progress s(t) comprises determining the time-dependent path progress s(t) such that the reachable velocity profile v(s) of the laser becomes maximum at least in sections along the machining path.

20. The method of claim 17, wherein determining the time-dependent path progress s(t) comprises determining the time-dependent path progress s(t) using an optimization method, wherein multiple different time-dependent path progresses s(t) are determined in the optimization method and, from among these, the time-dependent path progress s(t) which yields the shortest machining time of the machining path is selected.

21. The method of claim 17, wherein determining the time-dependent path progress s(t) comprises determining the time-dependent path progress s(t) such that a dynamic limit of the laser is adhered to.

22. The method of claim 17, wherein determining the time-dependent path progress s(t) comprises determining the time-dependent path progress s(t) such that the dynamic limit of the galvo scan system that is adhered to is an acceleration limit and/or a jerk limit.

23. The method of claim 17, wherein determining the time-dependent path progress s(t) comprises determining the time-dependent path progress s(t) such that the time-dependent path progress, the reachable velocity profile, and/or profiles which can be derived from the time-dependent path progress and/or the reachable velocity profile are continuous and/or continuously differentiable.

24. The method of claim 17, wherein the location-dependent energy input profile E(s) and/or the location-dependent first power profile L₁(s) and/or the location-dependent idealized velocity profile vₘₐₓ(s) are calculated and/or defined such that these are staircase-shaped and/or constant in at least some path sections along the machining path.

25. The method of claim 17, wherein an orientation and/or a positioning of the galvo scan system with respect to the machining path is also taken into account in the calculation of the time-dependent second power profile L₂(s(t)) and/or of the location-dependent idealized velocity profile vₘₐₓ(s).

26. The method of claim 17, further comprising determining, on the basis of the time-dependent path progress s(t), time-dependent coordinates p(s(t)) for the machining path for the galvo scan system for moving the laser along the machining path.

27. The method of claim 26, further comprising transmitting the coordinates p(s(t)) to a control unit of the galvo scan system and transmitting the time-dependent second power profile L₂(s(t)) is transmitted to a laser controller.

28. The method of claim 17, further comprising simulating the laser machining prior to the real laser machining of the object, and/or the real laser machining of the object is carried out after optimizing the time of laser machining and/or after simulating the laser machining.

29. A computer program which, when run by the one or more computer units, prompts the one or more computer units to carry out the method of claim 17.

30. A computer-readable storage medium, comprising a computer program, wherein the computer program, when run by the one or more computer units, prompts the one or more computer units unit to carry out the method of claim 17.

31. A laser machining device for laser machining an object, comprising:
a laser for laser machining,
a galvo scan system for guiding the laser over the object, and
one or more computer units configured to carry out the method of claim 17.
